(19) United States
(12) Patent Application Publication
(10) Pub. No.: US 2012/0128568 A1
(43) Pub. Date: May 24, 2012

(54) PRODUCTION OF SILANES FROM SILICON ALLOYS AND ALKALINE EARTH METALS OR ALKALINE EARTH METAL SILICIDES

(75) Inventor: Dominique Belot, Le Chesnay (FR)

(73) Assignee: L' Air Liquide, Societe Anonyme pour I'Etude et"Exploitation des Procedes Georges Claud, Paris (FR)

(21) Appl. No.: 13/383,995

(22) PCT Filed: Jun. 28, 2010
(86) PCT No.: PCT/FR2010/051335

§ 371 Date: Jan. 13, 2012

(30) Foreign Application Priority Data
Jul. 22, 2009 (FR) 0955128

(51) Int. Cl. C01B 33/04; B01J 19/00

(52) U.S. Cl. 423/347; 422/187

(57) ABSTRACT

The invention relates to a method for preparing a compound or mixture of compounds of the formula SiₙH₂ₙ₊₂, where n is an integer greater than or equal to 1 and less than or equal to 3, said method including a step a) of reacting at least one silicide or silicon alloy in powder form and having the formula M¹ₓM²_{y}Si_{z}, where M¹ is a reducing metal, M² is an alkaline metal or alkaline earth metal, and x, y, and z vary from 0 to 1, z being different from 0 and the sum x+y being different from 0, with chlorhydric acid being pre-dissolved in an ether aprotic solvent.

The present invention relates to the production of silicon hydrides or silanes from silicon alloys or from silicides.

Certain silanes, and more particularly monosilane or silicon tetrahydride (SiH₄), are used as silicon vector in techniques for depositing amorphous silicon, polycrystalline silicon, nanocrystalline or single-crystal silicon also called nanomorph or micromorph silicon, silica, silicon nitride or other silicon compounds, for example in vapor deposition techniques.

The thin-film deposition of amorphous silicon and single-crystal silicon obtained from silane allows the manufacture of solar cells.

It is also possible to obtain coatings that are resistant to acid corrosion, by silane cracking and manufacture of compounds such as silicon carbide.

Finally, the silane can be added onto the single or multiple bonds of unsaturated hydrocarbons in order to give organosilanes.

The market for monosilane is experiencing very substantial expansion both for the fabrication of integrated semiconductors and the manufacture of thin-film or crystalline solar (photovoltaic) cells, semiconductor components and the manufacture of flat screens.

Several types of process described below have been used hitherto.

Firstly, the reduction of SiCl₄ by LiH in a KCl/LiCl bath at temperatures between 450° C. and 550° C. is known. The reaction yield is high, but the process relies, on the one hand, on the availability of LiH, although lithium resources are very limited, and, on the other hand, on the possibility of recycling the lithium metal by electrolysis. The reaction mixture is very corrosive and employs particular materials. This process has been used to produce small amounts of silane.

The reduction of SiF₄ by NaAlH₄ in an organic solvent medium is another example. This process is industrially viable only when SiF₄, the byproduct of another chemical production process, and sodium are present for manufacturing sodium aluminum hydride. This process is not easily utilizable, especially for the above two reasons.

Another known reaction is the chemical attack in liquid NH₃ medium of a stoichiometric Mg₂Si alloy. The reaction balance is the following:

Mg₂Si+4HCl→SiH₄+2MgCl₂ liquid NH₃

This process is carried out at a temperature close to room temperature and at atmospheric pressure. Magnesium silicide (Mg₂Si) has been thoroughly tested in aqueous and ammoniacal medium. Although sufficiently acceptable for being carried out in industrial production units, the process has the following major drawbacks:
industrial magnesium silicide, because of the volatility of magnesium, contains only 70% to 80% of the stoichiometric compound. The conditions for manufacturing the stoichiometric compound involve a product too expensive for this industry; and
at the same time as monosilane is being produced by this route, many higher silanes, including polychlorosilanes, siloxanes and silicone rubbers, are being produced, making the monosilane material balance poor and incurring major process control difficulties.

This process is unsatisfactory because of the difficulty in controlling the process and of the highly regulated use of liquid ammonia.

Another known reaction is the dismutation of SiHCl₃ on resins containing grafted amine groups or the like. The complete process is thus expressed by:
a) 4Si_{Metal}+12HCl→4SiHCl₃+4H₂ (temperature between about 300° C. and about 1000° C.);
b) 4SiHCl₃←→SiH₄+3SiCl₄ (temperature close to room temperature);
c) 3SiCl₄+3H₂→3SiHCl₃+3HCl (temperature of about 1000° C.) i.e. the following reaction balance:

4Si_{Metal}+9HCl→SiH₄+3SiHCl₃+H₂.

A variant of the above reaction is thus given by:
a) 4Si_{Metal}+16HCl→4SiCl₄+8H₂ (temperature between about 1000° C. and about 1100° C.)
b) 4SiCl₄+4H₂→4SiHCl₃+4HCl (temperature of about 1000° C.)

4SiHCl₃→SiH₄+3SiCl₄,

i.e. the following reaction balance:

4Si_{Metal}+12HCl→SiH₄+3SiCl₄+4H₂.

This process requires high temperatures in an extremely corrosive medium and consumes a great deal of energy (about 50 kWh/kg for step b)). To achieve the maximum yield, step b) requires many chlorosilane mixture recirculation loops. Apart from the use of extremely corrosive, toxic and inflammable products, such a type of process is very expensive in terms of energy and is subject to many industrial risks.

The production of monosilane and higher silanes has been described in the Gmelin Handbook of Inorganic Chemistry: Si-Silicon, by reacting, in aqueous phase, silicides and silicon alloys in acid or basic medium. Patent applications EP 146 456 and WO 2006/041272 describe the synthesis of monosilane in aqueous phase by dropping an AlₓSi_{y}Ca_{z} powder, where x, y and z represent the percentage contents of aluminum, silicon and calcium respectively, into an HCl solution. The composition of the gases produced is approximately 80% monosilane, 10% disilane, 5% trisilane and traces of disiloxane. This type of process has the drawback of having to handle and store pure or highly concentrated HCl. Byproducts resulting from such a reaction are produced in large quantity and are deleterious to the environment (particularly chlorides). Another drawback of such a process is the abundant formation of foam in the reaction mixture, thereby reducing the reaction yield and requiring the presence of an antifoam. Such a reaction is highly exothermic and temperatures above 100° C. are quite rapidly reached if the rate of introducing the alloy powder is not considerably reduced.

All these studies described above fail to guarantee the conditions necessary for carrying out an efficient process for industrial development. The development of processes involving less difficult reaction conditions and/or able to be carried out in small or medium-sized units, in practically all environments and close to points where the monosilane is will be used, is a major challenge for the abovementioned industries.

A simple process, using inexpensive raw materials and producing silicon hydrides with an industrial yield, but avoiding all the above drawbacks, has been found.

The purpose of the present invention is to alleviate all or some of the abovementioned drawbacks of the prior art. The object of the invention described hereafter is to propose additional optimizations of the process starting from AlSiCa alloys, while minimizing the abovementioned drawbacks.

For this purpose, one subject of the invention is a process for preparing a compound or a mixture of compounds of formula SiₙH₂ₙ₊₂ in which n is an integer equal to or greater than 1 but less than or equal to 3, comprising a step a) of reacting at least one silicide or silicon alloy in powder form, of formula M¹ₓM²_{y}Si_{z} in which M¹ is a reducing metal, M² is an alkali or alkaline-earth metal, x, y and z vary from 0 to 1, z being different from 0, and the sum x+y differing from 0, with hydrochloric acid dissolved beforehand in an ether-type aprotic solvent. The reducing metals are for example Al, B, Ga and In, the alkaline metals are for example Li, Na, K and Cs and the alkaline-earth metals are for example Mg, Ca, Sr and Ba.

Moreover, embodiments of the invention may comprise one or more of the following features:
in the process as defined above, said aprotic solvent is tetrahydrofuran (THF)
the above process is characterized in that M¹ is aluminum and M² is calcium or magnesium;
the above process is characterized in that the silicon alloy has the formula CaAl₂Si₂;
the above process is characterized in that the hydrochloric acid/tetrahydrofuran solution is injected so as to permanently remove the chlorides formed during the reactional step a) from the surface of the silicide or silicon alloy;
the above process is characterized in that step a) is carried out at a temperature between 20° C. and 130° C. and at a pressure between 1 bar and 10 bar;
the above process is characterized in that the particle size of the silicon alloy is between 0.2 mm and 0.9 mm and preferably between 0.2 mm and 0.5 mm;
the above process further includes a step of recycling said aprotic solvent not used during step a), by heating said solvent to a temperature above 170° C.; and
the above process comprises the following steps:
a′) mixing of hydrochloric acid with a crown ether such as tetrahydrofuran;
b′) mixing said silicon alloy with the mixture resulting from a′); and
c′) fractional distillation at a pressure close to atmospheric pressure, intended for separating the monosilane from the higher silanes and other volatile compounds.

The subject of the present invention is also an on-site unit, for implementing the silane production process as defined above, comprising:
at least one reactor equipped with means for introducing the powdered silicon alloy and means for introducing a solution of a crown ether, such as tetrahydrofuran, containing hydrochloric acid;
a purification circuit comprising a fractionating column for separating the silanes and a double distillation column for recovering the pure monosilane and/or a silane/disilane mixture; and
at least one recycling means intended for recycling, into the reactor, the crown ether, such as tetrahydrofuran, not used during the reaction between said silicon alloy and the hydrochloric acid dissolved beforehand in the crown ether, such as tetrahydrofuran.

The silicon alloy is chosen from CaAl₂Si₂, Si_{0.5}Mg, Si_{0.5}Ca, AlSiCa, CaSi, Ca_{0.5}Si, MgSi, AlSiNa, AlSiMg, SiNa, AlSiLi, SiK, Ca_{0.5}AlSi_{0.33} and Ca_{0.5}AlSi_{0.75} or a mixture thereof, preferably Si_{0.5}Mg, AlSiNa, SiNa, Si_{0.25}Li, Si_{0.25}Na, Si_{0.25}K or SiK. Other silicon alloys suitable for the present invention are alloys of the ferrosilicon type, for example FeSi, FeSiMg and FeSiCa.

Preferably, the alloy used in the process forming the subject of the present invention is the composition CaAl₂Si₂, which is the most active phase giving the best yields.

The term “higher silanes” is understood to means the compounds of formula SiₙH₂ₙ₊₂, n≧2, including disilane, trisilane and tetrasilane.

The alloys or silicides employed in implementing the process according to the invention are alloys or silicides also serving to control the foaming and the deoxidization of slags in steelworks. They are low cost industrial products and easy to produce. One of the advantages of the process forming the subject of the invention is the ability to bring about the reactions under conditions close to ambient (temperature and pressure) conditions in standard equipment in the inorganic chemical industry such as glass-lined reactors for example. Processes involving these alloys or silicides may allow the silane to be produced in small or medium-sized units operating as close as possible to the markets. Irrespective of the alloys and silicides available and the operating and environmental constraints, the same unit can be used, by adjusting the operating parameters. In all cases, the byproducts are recyclable or reusable inorganic products.

It has also been discovered that the particle size of the alloy powder has an influence on the reaction rate and consequently on the reaction yield. The rate increases when the particle size decreases. The factor limiting the particle size is the formation of foam during the reaction. When the particle size is reduced by a factor of 10, all other conditions being the same, the amount of silane produced in the same time increases by a factor of about 15.

The process according to the invention also has the advantage that the proportion of monosilane formed relative to all the silanes produced during the reaction is at least 60%, this being an important factor given the fact that the desired silane for the applications intended by the present invention is most particularly monosilane.

According to a preferred embodiment of the present invention, the alloy employed is CaAl₂Si₂. The inventors have found that, surprisingly and unexpectedly, this is the alloy that gives the best results.

The theoretical monosilane production equation is expressed as follows:

CaAl₂Si₂+8HCl→2SiH₄+2AlCl₃+CaCl₂,

that is to say, for a 100% yield:
SiH₄ 1 kg
HCl 4.56 kg
AlCl₃ 4.17 kg
CaCl₂ 1.74 kg.

For comparison, the equation based on Mg₂Si is as follows:

Mg₂Si+4HCl→SiH₄+2MgCl₂,

that is to say, for a 100% yield:
SiH₄ 1 kg
HCl 4.56 kg
MgCl₂ 5.94 kg.

It may be seen that the two routes result in equivalent material balances. According to one particular embodiment, the present invention relates to an aluminum alloy reaction containing at least 90% CaAl₂Si₂ and less than 10% CaSi₂ by weight.

The process forming the subject of the present invention employs an aprotic solvent of the ether type, and preferably tetrahydrofuran (THF). Other solvents are conceivable, for example diethyl ether, dimethyl ether, diglyme (di(2-methoxyethyl)ether) and triglyme.

Such a solvent has the advantage of avoiding the formation of siloxanes and silicon hydroxides.

In one exemplary embodiment of the process according to the invention, the hydrochloric acid (HCl) is firstly dissolved in a solvent, such as THF, so as to form a homogeneous reaction medium.

THF dissolves very many alkaline-earth metal and aluminum chlorides by virtue of its crown ether function, and the HCl acid dissolved in the THF reacts very rapidly with the metals to form the corresponding chlorides which at the same time dissolve in the THF. By virtue of this HCl-acid-enhanced “activity” of the metals, the reaction will be preferentially aimed at the production of metal chlorides (such as AlCl₃) instead of the competing production of chlorosilanes.

In a preferred embodiment of the process according to the invention the HCl/THF solution is injected so as to permanently “wash” the surface of the alloy so as to result in the almost complete reaction of the solid medium and in a proportion such that there is no excess unreacted HCl present in the medium.

It is known that during silane production from Mg₂Si, as described above, the reaction of HCl in aqueous or liquid ammoniacal medium is accompanied by the formation of higher silanes ranging up to highly viscous inflammable silicone rubbers. This is explained by the fact that the Si—H bond is very labile with a pronounced (Si⁺—H⁻) ionic character. Chlorides including MgCl₂, CaCl₂ and AlCl₃ easily catalyze the linear or branched polymerization so as to give chains of the H—(SiH₂)ₙ—H type. During implementation of one particular embodiment of the process forming the subject of the present invention, the HCl/THF solution washes the alloy powder so as to permanently dissolve the chlorides. Thus the desired silanes are separated from the chlorides immediately after their formation.

Furthermore, with the temperature remaining well below 200° C., the risk of forming chlorosilanes by reaction between the light silanes and HCl is very low.

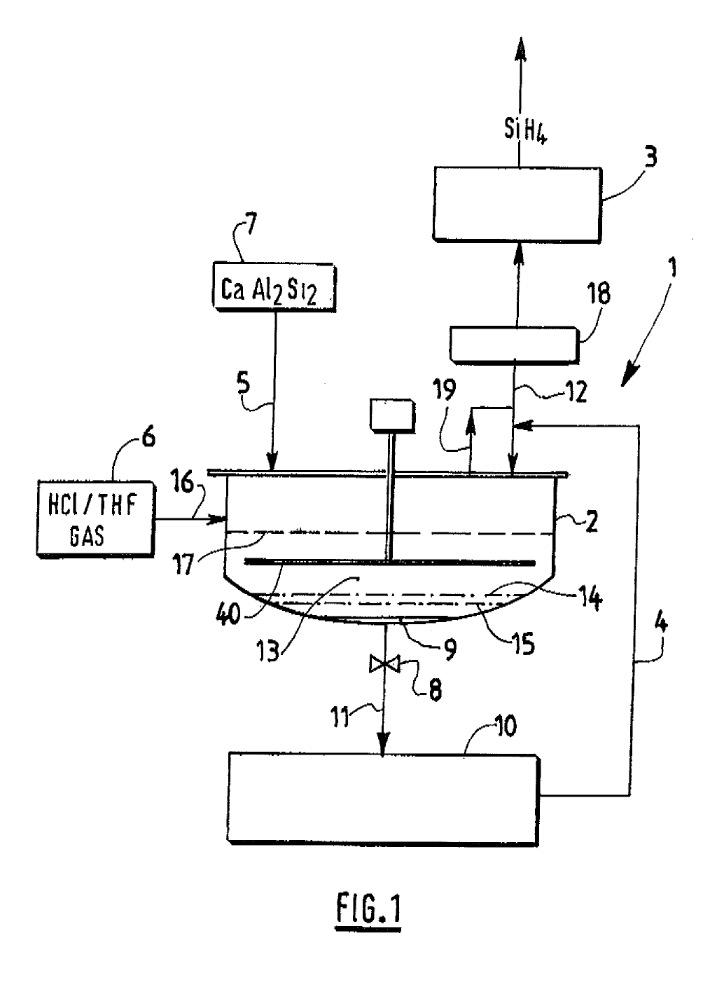

Other features and advantages will become apparent on reading the description below, given with reference to FIG. 1:

FIG. 1 shows a diagram of an installation used for implementing the process according to the invention.

The production unit 1 comprises at least three parts, containing a reactor 2, a purification system 3 and a system 4 for recycling the solvent coming from the reactor 2.

The silane production reaction takes place in a reactor 2 provided with a mixing means 40, such as a scraper or a mixer. The reactor 2 is filled, on the one hand, with a silicon alloy, such as CaAl₂Si₂ coming from a source 5 and, on the other hand from a source 6 of a solution containing an acid, such as for example HCl, mixed beforehand with an aprotic solvent of the ether type, such as THF, the proportions of the mixture being chosen by the user prior to the reaction for the purpose of obtaining the best possible yield given the abovementioned problems to be solved. A cover may for example be clamped to the reactor 2, said cover being removable from above and fixed by bows. The cover has a sealed opening allowing a sealed hopper 7 to be connected. Preferably, the reactor is surrounded by thermal insulation.

A silicon alloy flow means 7 is close to the reactor 2. Such a flow means is for example a hopper 7 initially filled with a silicon alloy in the form of powder having the formula M¹ₓM²_{y}Si_{z} in which M¹ is a reducing metal, M² is an alkali or alkaline-earth metal, and x, y and z vary from 0 to 1, z being different from 0. Preferably the alloy is CaAl₂Si₂. For example, the hopper 7 has a feed screw and constriction duct enabling the hopper 7 to be isolated from the reactor 2. The design of the hopper 7 is for example similar to the hoppers used for pouring calcium carbide into acetylene reactors. The alloy is supplied in drums similar to the drums used for transporting calcium carbide in acetylene production units.

According to one particular embodiment of the invention, above the cover of the reactor 2 are two gas-tight isolating valves in series, comprising, between the two, a lateral tap-off for purging the reactor 2 before disconnection. A similar device 8 is provided at the outlet, at the bottom of the reactor 2, for removing the liquids. The bottom of the reactor 2 is closed off by a means 9, for example a dome, preventing liquid products from stagnating in the bottom channel. This dome is raised by actuating the bottom valve 8. The liquids are sent into a crystallizer system 10 via a line 11.

To recover the desired silanes, the products pumped from the reactor 2 that are not sent into the crystallizer system 10 are directed into a purification system 3 via a line 12. Said purification system 3 comprises at least one fractionating column for separating the silanes from the other products present, and finally a double distillation column for recovering the pure monosilane, subsequently used for the desired applications. Also provided is a fractionating system capable of delivering a silane/disilane mixture.

For this purpose, the use of a mixture containing about 80% silane and about 20% disilane may be envisaged in silicon deposition techniques.

Thus, according to one particular embodiment, the subject of the invention is a process and a production unit for continuously producing mixtures of gaseous silanes including monosilane/disilane mixtures. These mixtures can be used directly for the manufacture of thin-film solar cells. The process allows the production of mixtures having a typical composition consisting of 80% monosilane and 20% disilane by volume.

The powder of the compound (the silicon alloy, for example CaAl₂Si₂) is continuously introduced into the reactor 2 by the hopper 7. The reactor 2 has a slightly frustoconical first bottom 13 consisting of metallic filtering media 15 on which an organic filtering media 14, for example a filter paper, is added, the purpose of which is to retain the particles that have not reacted. The frustoconical bottom 13 contains, in the middle thereof, a hole closed off by a plug mechanically removable from the outside. The reactor 2 also contains a scraper 40, the function of which is to stir the powder of the compound.

Gaseous acid, for example hydrochloric acid (HCl), is injected by diffusers 16 above the maximum level 17 provided for the level of solid contained in the frustoconical bottom. The liquid aprotic solvent, such as THF, comes from the condenser or condensers 18 to above the reactor 2. The gaseous THF coming from the crystallizer or crystallizers 10 is injected into the reactor 2, beneath the condensers 18. In a particular example of implementing the present invention by the device described here, the powder of the alloy compound injected by the hopper 7 firstly encounters an atmosphere composed of gaseous THF and gaseous HCl, and then a liquid containing the HCl/THF mixture. The alloy compound therefore starts, before encountering the frustoconical bottom, to come into contact with the gaseous HCl and THF, in order to form silanes that are discharged into the purification system 3 via the line 19. The chlorides, such as AlCl₃ or CaCl₂ obtained from the reaction between the alloy and the HCl dissolved in the solvent, are themselves dissolved by the THF present in the frustoconical bottom 13 and then discharged via the line 11 and the liquid discharge system 8. These liquid products (CaCl₂, AlCl₃, THF, etc.) then reach the system of crystallizers 10. Once the THF solution containing the chlorides (CaCl₂ and AlCl₃) has passed through the layer of alloy compound resting on the frustoconical bottom 13, said solution is directed through one or more crystallizers 10 operating at above 170° C. to evaporate the THF and precipitate the solid chlorides. These chlorides may be either extracted as such, to be recycled, or dissolved in water in order to make a brine transported to recycling units. By virtue of the liquid stream flowing using THF coming from the condensers 18, the HCl vapor that has not reacted and the dust of the alloy compound are trapped and carried into the frustoconical bottom 13 where there is a layer of the alloy compound that has not yet reacted. The liquid HCl/THF stream passes through this layer, reacting with the alloy compound, while the THF dissolves the chlorides formed beforehand. Preferably, the process is regulated so that the flow rate of THF flowing in the reactor 2 is 4 to 5 times the mass flow rate of HCl. The general conditions for the reaction are preferably between 1 bar and 10 bar in the case of the pressure and between 50° C. and 130° C. in the case of the temperature. One advantage of THF is it dissolves the silicone polymers that might form during the reaction. Thus, the THF is recycled by heating the solution after reaction to at least 170° C.

Furthermore, the THF can dissolve the silicon polymers that could be deposited on the cold walls of the system.

1-10. (canceled)

11. A process for preparing a compound or a mixture of compounds of formula SiₙH₂ₙ₊₂ in which n is an integer equal to or greater than 1 but less than or equal to 3, comprising:
step a) reacting hydrochloric acid dissolved in an ether-type aprotic solvent with a silicon alloy in powder form, the silicon alloy being selected from the group consisting of CaAl₂Si₂, AlSiCa, Ca_{0.5}AlSi_{0.33}, Ca_{0.5}AlSi_{0.75}, and mixtures thereof.

12. The process as claimed in claim 11, wherein the silicon alloy is CaAl₂Si₂.

13. The process as claimed in claim 11, wherein the aprotic solvent is tetrahydrofuran (THF).

14. The process as claimed in claim 13, further comprising removing chlorides formed during step a) from the surface of the silicon alloy by injecting hydrochloric acid dissolved in THF into a reactor containing the silicon alloy.

15. The process as claimed in claim 11, wherein step a) is carried out at a temperature between 20° C. and 130° C. and at a pressure between 1 bar and 10 bar.

16. The process as claimed in claim 11, wherein a particle size of the silicon alloy is between 0.2 mm and 0.9 mm.

17. The process as claimed in claim 16, wherein the particle size of the silicon alloy is between 0.2 mm and 0.5 mm.

18. The process as claimed in claim 11, further comprising recycling aprotic solvent not used during step a) by heating the solvent to a temperature above 170° C.

19. A process for preparing a compound or a mixture of compounds of formula SiₙH₂ₙ₊₂ in which n is an integer equal to or greater than 1 but less than or equal to 3, comprising:
a′) mixing hydrochloric acid with a crown ether to form a mixture;
b′) mixing the mixture with a silicon alloy selected from the group consisting of CaAl₂Si₂, AlSiCa, Ca_{0.5}AlSi_{0.33}, Ca_{0.5}AlSi_{0.75}, and combinations thereof to produce a product; and
c′) distilling the product by fractional distillation at a pressure close to atmospheric pressure, intended for separating monosilane from higher silanes and other volatile compounds.

20. The process of claim 19, wherein the crown ether is tetrahydrofuran.

21. An on-site unit (1) for implementing a silane production process for preparing a compound or a mixture of compounds of formula SiₙH₂ₙ₊₂ in which n is an integer equal to or greater than 1 but less than or equal to 3, comprising:
at least one reactor (2) equipped with means (5, 7) for introducing a silicon alloy and means (6, 12) for introducing a solution of a crown ether containing hydrochloric acid;
a purification circuit (3) comprising a fractionating column for separating silanes and a double distillation column for recovering pure monosilane and/or a silane/disilane mixture; and
at least one recycling means (4) intended for recycling into the reactor (2) crown ether not used during a reaction between the silicon alloy and the solution of the crown ether containing hydrochloric acid.

22. The on-site unit of claim 21, wherein the crown ether is tetrahydrofuran.
